(19) United States
(12) Patent Application Publication
(10) Pub. No.: US 2002/0076520 A1
(43) Pub. Date: Jun. 20, 2002

(54) Magnetic fastening system

(76) Inventors: Alexander J. Neeb, Alpharetta, GA (US); Richard J. Schmidt, Roswell, GA (US); Stephen Clark Smith, Atlanta, GA (US)

Correspondence Address: Melanie I. Rauch, Pauley Petersen Kinne & Fejer, Suite 365, 2800 West Higgins Road, Hoffman Estates, IL, 60195, US

(21) Appl. No.: 09/737,284

(22) Filed: Dec. 14, 2000

(51) Int. Cl. B32B 3/06

(52) U.S. Cl. 428/100; 428/99

(57) ABSTRACT

A fastening system wherein complementary components each have engaging elements protruding from a backing, and an attractive magnetic force applied through the complementary components. The attractive magnetic force can be supplied by external magnets attached to the backings, or by using a magnetic composite to form the backings and/or the engaging elements. The fastening system is particularly beneficial when used in absorbent articles.

### BACKGROUND OF THE INVENTION

This invention is directed to a fastening system. A number of fastening systems, such as diaper fastening systems, incorporate a hook and loop system for easy fastening and release. The hook component typically includes a flat plastic sheet laminate with a number of protruding hooks that engage with a number of loops on a corresponding loop component. Individual hooks engage with individual loops. Such hook and loop fastening systems rely primarily on forces parallel to the plane of engagement that resist unfastening.

Since the forces parallel to the plane of engagement resist unfastening of the hook and loop fastening system, hook and loop components are typically separated from one another using forces perpendicular to the plane of engagement. However, with little resistance to the forces perpendicular to the plane of engagement, the hook and loop fastening system is susceptible to coming unfastened at unexpected, and often undesirable, times.

There is a need or desire for a fastening system with added fastening security in a direction perpendicular to the plane of engagement.

### SUMMARY OF THE INVENTION

The present invention is directed to a fastening system having magnetic attraction between corresponding components. In one embodiment, the corresponding components include a male component and a female component, such as a hook and loop fastening system. The hooks can be any suitable shape. In another embodiment, the corresponding components are self-engaging. Each self-engaging component can have flat-top hooks. In this embodiment, the self-engaging feature of the components can be attributable to the cylindrical symmetry of the individual hooks and a lattice backing from which the hooks protrude. The ability to interconnect, or self-engage, provides significant fastening security when engaged, due to the flat tops of the individual hooks. Merely a small degree of movement between two corresponding hooks along the interface forces the hook tops to entangle and therefore locks the two hooks together without any further slippage. To shear the two entangled hooks apart would require nearly the same amount of energy needed to shear all of the corresponding hooks apart. The self-engaging hooks provide fastening that is an order of magnitude stronger than traditional hook and loop systems.

The magnetic attraction between the corresponding components ensures that the engaged hooks and loops, or the engaged self-engaging hooks on two corresponding components, do not escape in the shear relaxed state. More specifically, the attractive magnetic force keeps the corresponding components together in a direction normal to the plane of engagement. Either generic use magnets can be placed behind each component for the magnetic attraction, or the magnetic effect can be processed into the same material of the hooks, loops, hook backings and/or loop backings, for example, using a magnetic composite.

With the foregoing in mind, it is a feature and advantage of the invention to provide a fastening system having added fastening security in a direction normal to the plane of engagement.

### BRIEF DESCRIPTION OF THE DRAWINGS

FIG. 1 is a side view of a hook component and a loop component, each having an externally attached magnet, prior to engagement with one another;

FIG. 2 is a side view of the hook component and loop component of FIG. 1 engaged with one another;

FIG. 3 is a side view of a pair of self-engaging fastening components, each having an externally attached magnet, prior to engagement with one another;

FIG. 4 is a side view of the pair of self-engaging fastening components of FIG. 3 engaged with one another;

FIG. 5 is a longitudinal view of an individual hook of a fastening component having a flat-top engagement portion;

FIG. 6 is a transverse view of an individual hook of a fastening component having a flat-top engagement portion;

FIG. 7 is a top view of a fastening component having a lattice backing;

FIG. 8 is a top view of a pair of self-engaging fastening components engaged with one another along perpendicular vectors;

FIG. 9 is a side view of a hook component and a loop component, each including a magnetic polymer, prior to engagement with one another; and

FIG. 10 is a side view of a pair of corresponding fastening components, each including a magnetic polymer, prior to engagement with one another.

### DEFINITIONS

Within the context of this specification, each term or phrase below will include the following meaning or meanings.

“Bonded” refers to the joining, adhering, connecting, attaching, entangling, embedding, or the like, of two elements. Two elements will be considered to be bonded together when they are bonded directly to one another or indirectly to one another, such as when each is directly bonded to intermediate elements.

“Lattice” refers to an open framework of overlaid materials, typically in a crisscross pattern.

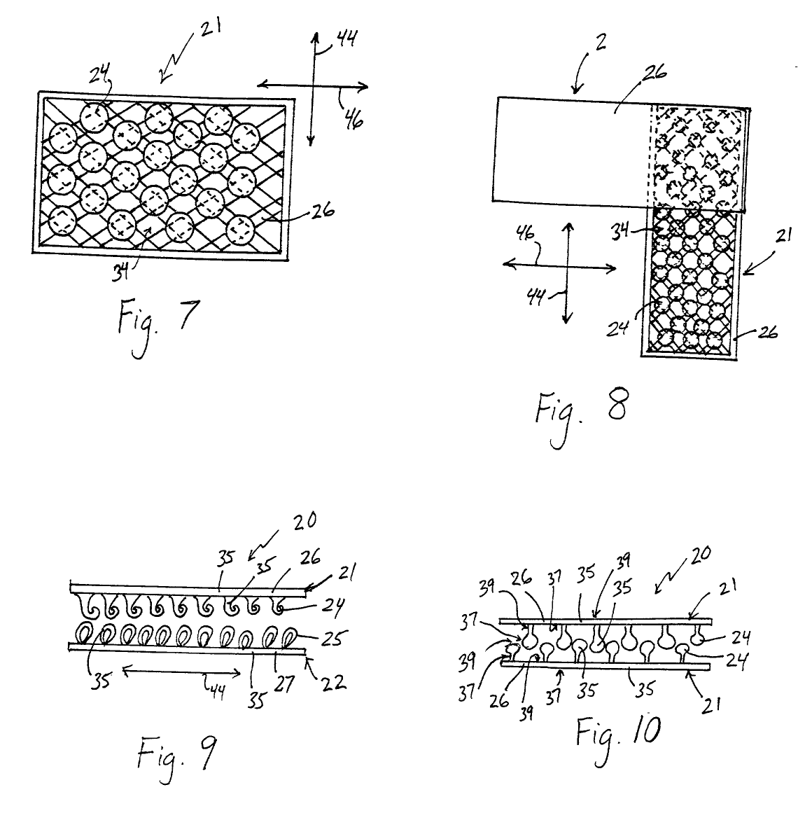

“Longitudinal” and “transverse” have their customary meaning, as indicated by the longitudinal and transverse axes depicted in FIGS. 7 and 8. The longitudinal axis lies in the plane of the article and is generally parallel to a vertical plane that bisects a standing wearer into left and right body halves when the pant-like article is worn. The transverse axis lies in the plane of the article generally perpendicular to the longitudinal axis.

“Magnet” refers to a material that has the power to attract, as well as be attracted to, other magnets or magnetically susceptible material.

“Magnetic composite” refers to a composition including magnetic materials as well as non-magnetic materials, with enough of the magnetic materials included therein to give the composition magnetic qualities.

“Magnetic element” refers to a material having magnetic properties, including pure magnetic substances as well as magnetic composites.

“Magnetically susceptible material” refers to a material composition to which magnets are attracted.

“Personal care garment” includes diapers, training pants, swim wear, absorbent underpants, adult incontinence products, feminine hygiene products, medical garments, and the like. The term “medical garment” includes medical (i.e., protective and/or surgical) gowns, caps, gloves, drapes, face masks, blood pressure cuffs, bandages, veterinary products, mortuary products, and the like.

“Polymers” include, but are not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

“Releasably attached,” “releasably engaged” and variations thereof refer to two elements being connected or connectable such that the elements tend to remain connected absent a separation force applied to one or both of the elements, and the elements being capable of separation without substantial permanent deformation or rupture. The required separation force is typically beyond that encountered while wearing the absorbent garment.

“Thermoplastic” describes a material that softens when exposed to heat and which substantially returns to a nonsoftened condition when cooled to room temperature.

These terms may be defined with additional language in the remaining portions of the specification.

### DETAILED DESCRIPTION OF THE PRESENTLY PREFERRED EMBODIMENTS

The present invention is directed to a fastening system having added fastening security in a direction normal to the plane of engagement between two fastening components. This fastening system is particularly suitable for use on disposable absorbent articles. Examples of such suitable articles include diapers, training pants, feminine hygiene products, incontinence products, other personal care or health care garments, including medical garments, or the like.

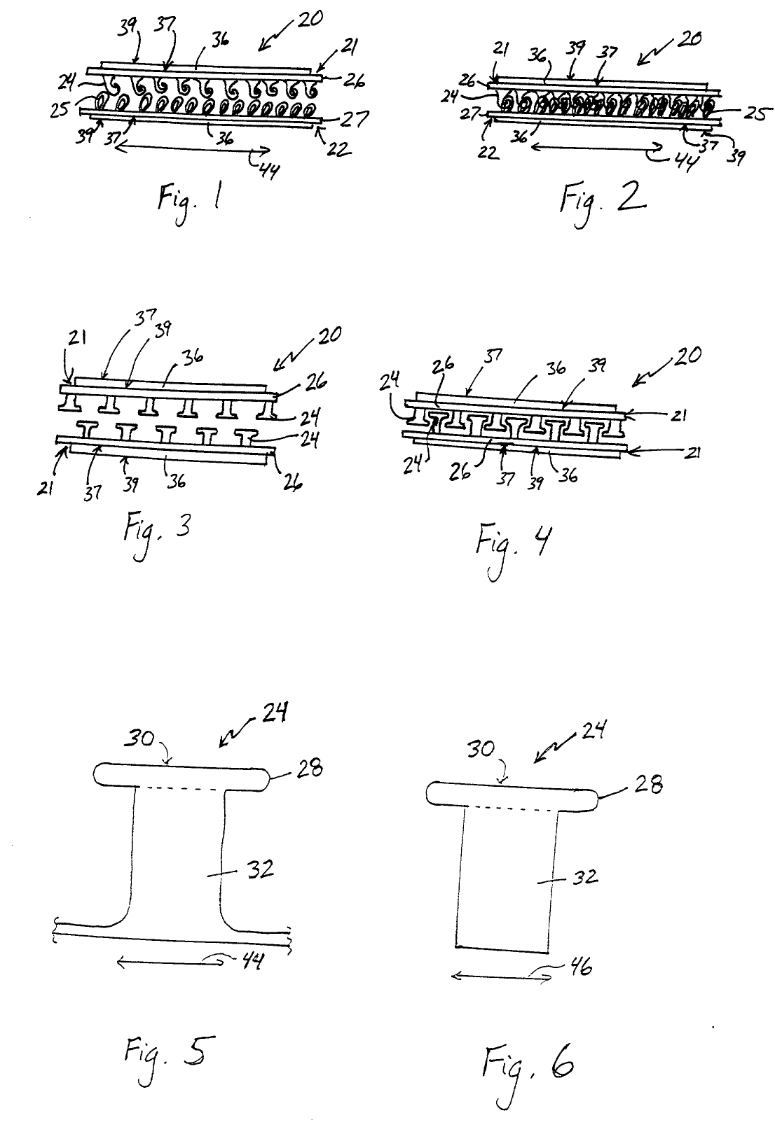

As shown in FIGS. 1 and 2, a fastening system 20 including two complementary fastening components 21, 22 can be brought together to be releasably attached, or releasably engaged, to one another. FIG. 1 shows a hook component 21 and a loop component 22 aligned for engagement prior to engagement. FIG. 2 shows the hook component 21 and the loop component 22 engaged with one another. The hook component 21 has a number of individual hooks 24 protruding generally perpendicularly from a hook backing material 26. Similarly, the loop component 22 has a number of individual loops 25 protruding generally perpendicularly from a loop backing material 27. The individual hooks 24 and the individual loops 25, when brought into contact with one another, engage with one another, with the hooks 24 latching onto the loops 25, until forcibly separated, thereby pulling the hooks 24 out of the loops 25.

In an alternative embodiment, shown in FIGS. 3 and 4, the hooks 24 can be self-engaging, meaning that the hooks 24 on each of two complementary hook components 21 are of the same shape and can engage with one another. More specifically, the individual hooks 24 of one hook component 21, when brought into contact with the individual hooks 24 of the other hook component 21, can be pressed together to engage with one another, as shown in FIG. 4. The hooks 24 of the two hook components 21 can be forcibly separated by pulling on either component 21.

Virtually any hook shape can be used with the hook component 21 of the invention. Suitable shapes include J-shaped, as shown in FIGS. 1 and 2, and flattop, as shown in FIGS. 3-6. The J-shaped hook 24 is more suitable for use with a corresponding loop component 22, while the flat-top hook 24 is suitable for use either with a corresponding loop component 22 or with a corresponding self-engaging hook component 21. Suitably, the individual hooks 24 have an engagement portion 28 at a free end 30 of each hook 24. The flat-top hook 24 shown in FIGS. 5 and 6 has a rounded engagement portion 28 with a flat top and can look the same in the longitudinal direction (FIG. 5) as in the transverse direction (FIG. 6), in which case a base portion 32 of the hook 24 is suitably round or square as viewed from above. Alternatively, the base portion 32 of the hook 24 can be oblong, rectangular, triangular, or any other suitable shape.

The longitudinal direction is indicated by an arrow 44 in FIGS. 1, 2, 5, 7, 8, and 9. The term “transverse direction” refers to a direction perpendicular to the longitudinal direction. The transverse direction is indicated by an arrow 46 in FIGS. 6, 7 and 8. In terms of a pant-like absorbent garment, the transverse direction of each fastening component located along a side of the garment is in a direction parallel to the wearer's waistline. Thus, the longitudinal direction of a fastening component 22 on a pant-like absorbent garment is in a direction parallel to a wearer's backbone.

The self-engaging feature of the flat-top hooks 24 can be attributable to the cylindrical symmetry of the individual hooks 24, and can be enhanced further with a lattice backing 26 from which the hooks 24 protrude. The lattice backing 26, shown in FIG. 7, increases the resistance applied to the hooks 24 parallel to the plane of engagement by providing pits 34 into which the engagement portions 28 of the hooks 24 can be lodged. The ability to interconnect, or self-engage, provides significant fastening security when engaged, due, in large part, to the flat tops of the individual hooks 24. Merely a small degree of movement between two corresponding hooks 24 along the interface of two corresponding hook components 21 forces the engagement portions 28 of the hooks 24 to entangle and, thus, locks the two hooks 24 together without significant further slippage. To separate the two entangled hooks 24 would require nearly the same amount of shear force necessary to separate all of the corresponding hooks 24 between the corresponding hook components 21. The self-engaging hooks 24 provide fastening that is an order of magnitude stronger than traditional hook and loop systems. Depending on the symmetry of the lattice backing 26, the hooks 24 on one of the hook components 21 may be engageable with the hooks 24 on the other hook component 21 when the two hook components 21 are aligned along perpendicular vectors, as shown in FIG. 8.

Further fastening strength is provided in this invention by the inclusion of a safe, non-toxic magnetic element 36 or 35, shown in FIGS. 1-4, 9 and 10. The magnetic attraction between the corresponding components 21, 22 insures that the free ends 30 of the hooks 24 do not escape from either corresponding loops 25 or corresponding hooks 24 in the shear relaxed state. More specifically, the attractive magnetic force keeps the corresponding components 21, 22 together in a direction perpendicular to the plane of engagement.

The magnetic element 36 can either be attached externally to the components 21, 22, as shown in FIGS. 1-4, or the magnetic element 35 can be incorporated in the hook and loop backings 26, 27 and/or in the hooks 24 and loops 25 (FIGS. 9 and 10). By attaching the magnets 36 to the backings 26, 27 or incorporating the magnetic element 35 within the components 21, 22, an attractive magnetic force is therefore applied to the hooks 24 and/or loops 25 through each backing 26, 27. Each magnet 36 has opposing surfaces 37 and 39 of positive and negative polarity, respectively. The opposing magnets 36 should be oriented to have reverse polarities, so that the positive pole 37 of a first magnet 36 is attracted to the negative pole 39 of a second magnet 36. Alternatively, the magnets 36 may be manufactured with alternating positive and negative poles 37, 39 along each surface of the magnets 36.

Virtually any type of generic use magnet 36, suitably a thin magnet, can be adhered to the backings 26, 27 of the components 21, 22, as shown in FIGS. 1-4. The magnets 36 can be bonded to the backings 26, 27 using an adhesive or any other bonding means well known to those having ordinary skill in the art, including thermal bonding, ultrasonic bonding, and the like.

Alternatively, the magnetic effect can be processed into the backing material 26, 27 and/or can be processed into the hook and loop material 24, 25 as a magnetic composite material 35, as shown in FIGS. 9 and 10. The magnetic composite 35 can include a polymer, for example polyamides, polyesters, polyolefins (e.g. polypropylene or polyethylene), or any other suitable material that can be combined with a magnetic material. The magnetic material can include any magnetic material, such as ceramics or metals, for example, ferrites, neodynium-iron-boron compounds, samarium-cobalt compounds, aluminum-nickel-cobalt compounds, or manganese-aluminum compounds. The magnetic composite 35 can be made by dispersing particles of a magnetizable material into a polymer and magnetizing it. As mentioned in reference to the magnets 36 in FIGS. 1-4, the magnetic material 36, 35 should be polarized so that one pole 37 of a first component 21 is attracted to the opposite pole 39 of a second component 21, 22, or alternatively, all surfaces of the magnetic composite 35 can have both positive and negative poles.

An attractive magnetic force can be produced between two magnets, but can also be produced between a magnet and a magnetically susceptible material. In each of the embodiments of the invention, rather than having one magnetic element 35, 36 attached to or incorporated within each fastening component 21, 22, a first fastening component 21, 22 can have a magnetic element 35, 36 attached to or incorporated within the first fastening component 21, 22 and a second fastening component 21, 22 can have a magnetically susceptible material, such as iron, attached to or incorporated within the second fastening component 21, 22. Also in each of the embodiments of the invention, the hooks 24 can be directly embedded in the hook backing material 26 to effectively create islands of hooks 24.

The hook components 21 in the present invention generally have between about 16 and about 620 hooks per square centimeter, suitably between about 124 and about 388 hooks per square centimeter, desirably between about 155 and about 310 hooks per square centimeter. The hooks 24 suitably have a height of from about 0.00254 centimeter (cm) to about 0.19 cm, suitably from about 0.0381 cm to about 0.0762 cm.

The hooks 24 are suitably molded or extruded from a thermoplastic polymer selected from polyamides, polyesters, polyolefins (e.g. polyethylene, polypropylene, polybutene, ethylene copolymers, propylene copolymers, or butene copolymers), a thermoplastic elastomer, or another suitable material. Likewise, the hook backing material 26, in addition to a magnetic material described above, can be made of any of these or any other suitable materials since the hooks 24 and the backing 26 are generally produced from the same material in one process. The backing material 26 generally has a thickness in a range of between about 0.4 millimeter (mm) and about 5 mm, suitably in a range of between about 0.6 mm and 2 mm, resulting in a total basis weight of the hook component 21 in a range of from about 20 grams per square meter to about 70 grams per square meter. The hooks 24 can be spatially arranged in rows or any other suitable discontinuous configuration on the hook backing 26.

The hook component 21 of the present invention can be made according to a method similar to that disclosed in U.S. Pat. No. 4,794,028 issued to Fischer, hereby incorporated by reference. More particularly, a heat softened synthetic resin, namely any of the suitable polymers mentioned herein, is extruded and shaped between a pair of rollers. One of the rollers has a plurality of projection-forming mold cavities about its periphery within which the hooks 24 of the hook component 21 are formed. Once the hooks 24 are cooled and at least partially solidified in the mold cavities, the hooks 21 are removed or stripped from the roller, remaining integral with the backing material 26, without a need to open the cavities. As indicated, the individual hooks 24 can be co-formed with the backing material 26.

The individual loops 25 of the loop component 22 can be needled, stitched or otherwise projected through the loop backing material 27, which can suitably be made from a nonwoven material. The individual loops 25 can suitably be made from a fibrous nonwoven web such as a spunbond nonwoven web, or a staple fiber carded web. Alternatively, the individual loops 25 can be made of yarn or tow. Once the loops 25 have been formed, fibers forming the loops can be anchored in place by bonding the fibers to the loop backing material 27 with heat and/or adhesives or any other suitable means.

The loops 25 are not necessarily of a uniform height, but preferably have a height in a range of from about 0.00254 cm to about 0.19 cm, or from about 0.0381 cm to about 0.0762 cm. The loop backing 27 is suitably no thicker than about 0.04 cm, more suitably no thicker than about 0.01 cm, even more suitably no thicker than about 0.0025 cm. The loop backing 27 should have a thickness of at least about 0.000254 cm, suitably at least about 0.000381 cm. The density of the loops 25 on the loop backing 27 is largely dependent on the type of material used, and can range from about 16 to about 620 loops per square centimeter, or from about 124 to about 388 loops per square centimeter, or from about 155 to about 310 loops per square centimeter.

Suitable backing materials for both the hook backing 26 and the loop backing 27 include nonwoven webs, laminates, films, stranded materials and “point unbonded” materials. Point unbonded materials are fabrics having continuous thermally bonded areas defining a plurality of discrete unbonded areas and are described in greater detail in U.S. Pat. No. 5,858,515 issued Jan. 12, 1999 to Stokes, et al. As used herein, the term “backing” can include the hooks 24 and/or loops 25 as an integral part of the backing material 26, 27.

The fastening system 20 of the present invention is designed to include a magnetic component 36 attached to the individual fastening components 21, 22 or integrated within the backings 26, 27 and/or the hooks 24 and loops 25 of the fastening components 21, 22. The result is a magnetic fastening system 20 that provides added fastening security in a direction normal to the plane of engagement between the fastening components 21, 22.

### EXAMPLE

The following example was carried out using a ProMag® magnet, part number 12349 available from ProMag Products of Marietta, Ohio, approximately 0.06 inch thick by 0.5 inch wide (1.5 mm×12.7 mm) on a flexible roll with adhesive and release paper. Due to pole spacing in the longitudinal direction of the magnets, the magnets were adhered to the back of both a hook component and a loop component with the longitudinal direction of the magnets along the transverse direction of the hook component and loop component. Aligning the magnets with the transverse direction of the magnets along the transverse direction of the hook component and loop component caused the pair to alternate between attraction and repelling as the hook component and loop component sheared from one another in the test.

Two 0.5 inch strips of the magnet, each 2 inches long, were taped side by side in the longitudinal direction on the back of the loop component. The loop component was 1.5 osy (ounces per square yard) point unbonded material, currently in use on HUGGIES ULTRATRIM DIAPERS®, made by Kimberly-Clark Corporation of Neenah, Wis., cut to 1 inch in the transverse direction and 6 inches in the longitudinal direction.

Four 0.5 inch strips, each 1 inch long, were taped side by side in the longitudinal direction on the back of the hook component. The hook component was made of VELCRO® HTH-851, available from Velcro, USA, of Manchester, N.H. , assembled into a commercial ULTRATRIM® diaper ear, having dimensions of 1 inch in the transverse direction and 2 inches in the longitudinal direction. Together, the hook component and the loop component produced one square inch of engaging area for the system.

Control samples were formed, using the same hook and loop component materials, but adhering the magnets to the back of the hook component only, not to the back of the loop component. Other than the magnets on the back of the loop components, the magnetic samples and the control samples were assembled and tested using the same methods.

The shear force value measures how well the hook and loop stay engaged against in-plane shear force and can be determined in accordance with the standard procedure ASTM D-5169, approved Sep. 15, 1991 and published Nov. 1991 with the following particulars. The loop component was placed under the clamping plate of a rolldown machine. The hook component was placed on top of the loop component and attached by the rolldown machine using a 4.5 pound (2 kg) roller. A suitable rolldown machine is part number HR-100 available from Chemsultants International, of Mentor, Ohio. During the engagement of the fastener components, the roller was rolled over the test specimen through five cycles in the direction of the cross-wise “width” of the sample. After the hook and loop were properly attached, the combination was placed in the testing apparatus, an Instron Model 2712-004 tensile tester with 102 mm (4 inch) rubberized grip faces (Instron Corporation, Canton, Mass.). The hook base was inserted in the upper grip and the loop in the lower in such a manner that the movement of the grips away from each other would result in the peeling apart of the two materials. Slack was removed and the machine was started. The tester was set with a crosshead speed of 300 mm/min and a gage length of 76 mm. Measurements were begun at 10 mm and ended at 46 mm and were in grams. The reported value of a shear test result was a peak load value employing MTS TESTWORKS software with a peak criteria of 2%. Additionally, the shear force value was normalized to be stated in terms of force per unit area of the test specimen, such as grams-force per inch². The MTS TESTWORKS software is available from MTS Systems Corporation in Eden Prairie, Minn.

The control system had an average of 1,862 grams per square inch shear (392 grams standard deviation), whereas the magnetic test samples had a much higher average shear of 2,683 grams per square inch (803 grams standard deviation).

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

We claim:

1. A fastening system, comprising:
a first component having a plurality of first engaging elements protruding from a first backing;
a second component having a plurality of second engaging elements protruding from a second backing; and
an attractive magnetic force applied to the first engaging elements through at least one of the backings.

2. The fastening system of claim 1, wherein the attractive magnetic force is supplied by at least one magnet attached to a surface of each of the backings.

3. The fastening system of claim 1, wherein the attractive magnetic force is supplied by at least one magnet attached to a surface of at least one of the backings.

4. The fastening system of claim 3, wherein at least one of the backings comprises a magnetically susceptible material.

5. The fastening system of claim 3, wherein the plurality of first engaging elements comprises a magnetic composite.

6. The fastening system of claim 1, wherein the attractive magnetic force is supplied by a magnetic composite material within at least one of the backings.

7. The fastening system of claim 6, wherein at least one of the backings comprises a magnetically susceptible material.

8. The fastening system of claim 6, wherein the plurality of first engaging elements comprises a magnetic composite material.

9. The fastening system of claim 8, wherein the plurality of second engaging elements comprises a magnetic composite material.

10. The fastening system of claim 1, wherein the first component comprises a hook component and the second component comprises a loop component.

11. The fastening system of claim 1, wherein the first component and the second component comprise self-engaging components.

12. The fastening system of claim 11, wherein the first backing and the second backing each comprise a lattice.

13. The fastening system of claim 11, wherein the first engaging elements and the second engaging elements comprise flat-top hooks.

14. An absorbent article comprising the fastening system of claim 1.

15. A diaper comprising the fastening system of claim 1.

16. A training pant comprising the fastening system of claim 1.

17. A feminine hygiene product comprising the fastening system of claim 1.

18. An incontinence product comprising the fastening system of claim 1.

19. A medical garment comprising the fastening system of claim 1.

20. A hook and loop fastener comprising a hook component and a loop component:
the hook component including a hook backing, a plurality of hooks protruding from it, and a magnetic element incorporated with the hook component; and
the loop component including a loop backing and a plurality of loops protruding from it.

21. The hook and loop fastener of claim 20, wherein the magnetic element comprises a magnet attached to a surface of the hook backing.

22. The hook and loop fastener of claim 20, wherein the magnetic element comprises a magnetic composite within the hook backing.

23. The hook and loop fastener of claim 20, wherein the magnetic element comprises a magnetic composite within the plurality of hooks.

24. The hook and loop fastener of claim 20, wherein the loop component comprises a magnetically susceptible material attached to the loop backing.

25. The hook and loop fastener of claim 20, wherein the loop component comprises a magnetic element.

26. The hook and loop fastener of claim 25, wherein the magnetic element of the loop component comprises a magnet attached to a surface of the loop backing.

27. The hook and loop fastener of claim 25, wherein the magnetic element of the loop component comprises a magnetic composite within the loop backing.

28. The hook and loop fastener of claim 25, wherein the magnetic element of the loop component comprises a magnetic composite within the plurality of loops.

29. An absorbent article comprising the hook and loop fastener of claim 20.

30. A diaper comprising the hook and loop fastener of claim 20.

31. A training pant comprising the hook and loop fastener of claim 20.

32. A feminine hygiene product comprising the hook and loop fastener of claim 20.

33. An incontinence product comprising the hook and loop fastener of claim 20.

34. A medical garment comprising the hook and loop fastener of claim 20.

35. A hook and loop fastener comprising a hook component and a loop component:
the hook component including a hook backing and a plurality of hooks protruding from it; and
the loop component including a loop backing, a plurality of loops protruding from it, and a magnetic element incorporated with the loop component.

36. The hook and loop fastener of claim 35, wherein the magnetic element comprises a magnet attached to a surface of the loop backing.

37. The hook and loop fastener of claim 35, wherein the magnetic element comprises a magnetic composite within the loop backing.

38. The hook and loop fastener of claim 35, wherein the magnetic element comprises a magnetic composite within the plurality of loops.

39. The hook and loop fastener of claim 35, wherein the hook component comprises a magnetically susceptible material attached to the hook backing.

40. An absorbent article comprising the hook and loop fastener of claim 35.

41. A diaper comprising the hook and loop fastener of claim 35.

42. A training pant comprising the hook and loop fastener of claim 35.

43. A feminine hygiene product comprising the hook and loop fastener of claim 35.

44. An incontinence product comprising the hook and loop fastener of claim 35.

45. A medical garment comprising the hook and loop fastener of claim 35.
